(19) United States
(12) Patent Application Publication
(10) Pub. No.: US 2020/0269140 A1
(43) Pub. Date: Aug. 27, 2020

(54) LOCKSTEP CLIENT-SERVER ARCHITECTURE

(71) Applicant: MZ IP HOLDINGS, LLC, Palo Alto, CA (US)

(72) Inventor: Detmar Peterke, Pleasanton, CA (US)

(21) Appl. No.: 16/787,478

(22) Filed: Feb. 11, 2020

Related U.S. Application Data
(60) Provisional application No. 62/811,120, filed on Feb. 27, 2019.

(51) Int. Cl. A63F 13/77; G06F 9/52; H04L 29/06; H04L 29/08; A63F 13/35

(52) U.S. Cl. CPC A63F 13/77; G06F 9/52; H04L 67/38; A63F 2300/534; A63F 13/35; A63F 2300/402; H04L 67/1095

(57) ABSTRACT

A method includes sending, by a server to each of a plurality of client devices, initializing information at a start of a task in a client application running on each of the plurality of client devices. The method further includes receiving, by the server, an input message from one of the plurality of client devices, wherein the input message is generated from an interaction with the task in the client application. The method further includes generating, by a computer processing device of the server, updated information for the task in the client application based on the received input message. The method further includes sending, by the server, the updated information to each of the plurality of client devices while the task in the client application is running to maintain synchronism between the server and the plurality of client devices for the task.

### CROSS-REFERENCE TO RELATED APPLICATIONS

This application claims the benefit of U.S. Provisional Patent Application No. 62/811,120, filed Feb. 27, 2019, the entire contents of which are incorporated by reference herein.

### BACKGROUND

Client applications, particularly games, often send and receive instructions from a centralized server. For example, in a gaming application, the player can request that a server perform a particular action on each client device currently active in the game. Communication between the client devices and centralized server is critical to maintain efficient gameplay. Due to the centralized nature of the game architecture, the game would go offline when the server goes offline of otherwise fails. This may result in interrupted gameplay.

### DESCRIPTION OF THE DRAWINGS

FIG. 1 is a schematic diagram of a first example lockstep client-server system, in accordance with embodiments of the disclosure.

FIG. 2 is a schematic diagram of a second example lockstep client-server system, in accordance with embodiments of the disclosure.

FIG. 3 is an illustration of an example of a method of lockstep client-server operations, in accordance with embodiments of the disclosure.

FIG. 4 is an illustration of an example of a method of lockstep client-server replay operations, in accordance with embodiments of the disclosure.

FIG. 5 is an illustration of an example of a method of lockstep client-server recommendation operations, in accordance with embodiments of the disclosure.

FIG. 6 is a block diagram of an example computing device, in accordance with embodiments of the disclosure.

### DETAILED DESCRIPTION

Aspects of the disclosure relate to lockstep client-server architecture. Specifically, the present disclosure is directed to systems and methods for running a real-time multiplayer game (e.g., a mobile game, such as a massively multiplayer online (“MMO”) game or the like) or other suitable client application with a server and multiple clients in synchronized agreement about the state of the game or other client application.

For example, a use case for the present invention may include a client application (“app”) that can host real-time matches with multiple participants. Each person may play on their own client device (e.g., a mobile device, such as a smartphone, a tablet computer, or the like) that is connected to a server.

Merely for purposes of illustration and not limitation, a tower-defense game that contains multiplayer battle matches will be used as an example of such a client application to assist in describing the present invention. According to the present illustration, each instance of a match has a start state, and begins synchronized among the players. A match has a finite duration. Players are free to choose what inputs (e.g., actions, tasks, etc.) to make and when to make them, within the rules of the game. The behavior of the match plays out over time, affected by the inputs made by the players in real-time. It is expected that all client devices experience the same match, with the same sequence of inputs and the same outcome.

In one embodiment, gameplay may become interrupted if a centralized server controlling the gameplay goes offline or otherwise experiences an error. Advantageously, the methods and systems disclosed herein overcome the above challenges, and others, by maintaining synchronized applications on each of the client devices and server(s).

In one embodiment, processing logic of a computer processing device may send, by a server to each of a plurality of client devices, initializing information at a start of a task in a client application running on each of the plurality of client devices. Initializing information may include setup data that allows each client device and server to execute identical copies of deterministic applications such that the same actions may be performed by each of the client devices and servers at the same time without communication with each other.

Processing logic may further receive, by the server, an input message from one of the plurality of client devices, wherein the input message is generated from an interaction with the task in the client application. In one embodiment, the input message may include a request from a user to perform the particular task (e.g., a move in a game, an annotation to a shared document, etc.), as well as an identifier of the frame (e.g., a graphics or video frame) during which the task should be performed.

Processing logic may further generate, by a computer processing device of the server, updated information for the task in the client application based on the received input message. For example, in one embodiment, the updated information may include instructions to perform the particular task at a particular time (e.g., as indicated by a frame identifier). In one embodiment, the particular time may be determined based on a requested time or a time generated by the server.

Processing logic may further send, by the server, the updated information to each of the plurality of client devices while the task in the client application is running to maintain synchronism between the server and the plurality of client devices for the task. Processing logic may further record a log of each of the actions performed in a particular task of a client application, such that tasks of applications may be replayed without replaying a video of the tasks being performed. In other words, games may be replayed and displayed by re-executing all actions taken during the game, without recording the actual gameplay itself. Advantageously, such techniques may result in a much smaller data file being maintained or otherwise substantially reduced data storage requirements (e.g., a video/screen capture is not required to be stored) while allowing all replay features to be performed (e.g., fast forward, rewind, pause, etc.).

Although examples of the disclosure may be described in the context of a mobile video game application, such examples are for illustrative purposes only. Aspects of the disclosure may be utilized by any client applications that use any kind of collaborative environment and/or entities. For example, aspects of the disclosure may be used by collaborative editing software, collaborative presentation software, collaborative viewing software, etc.

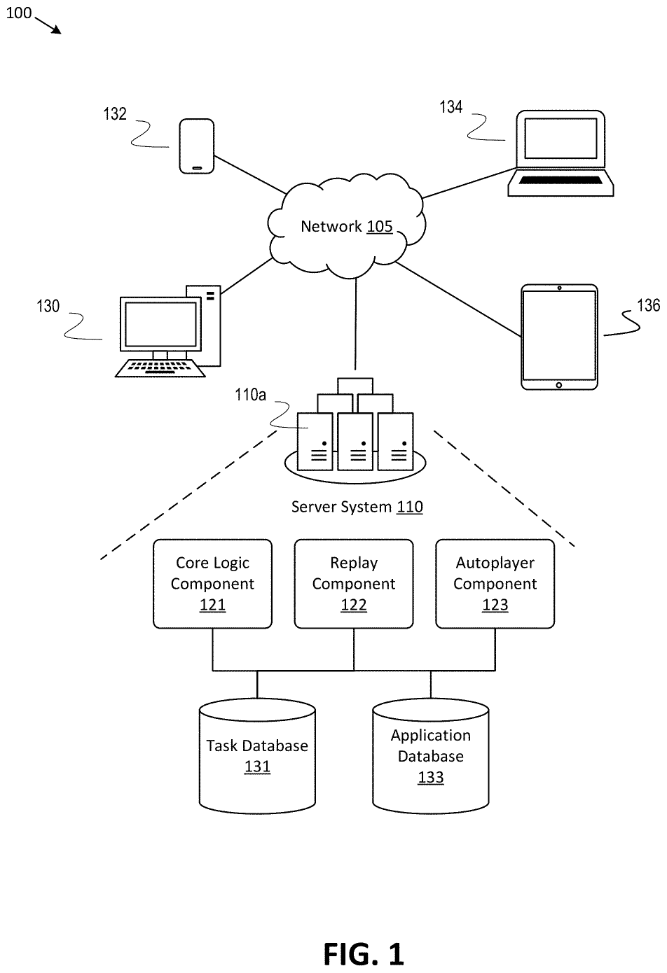

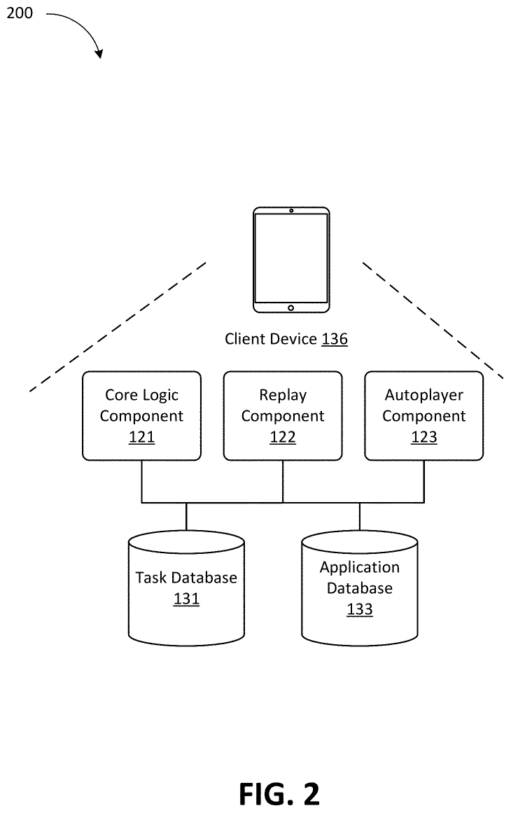

FIG. 1 schematic diagram of a first example lockstep client-server system 100, in accordance with embodiments of the disclosure. A server system 110 including one or more servers 110a provides functionality for operating and managing an online application used by users via client devices 130-136, including installs of an online application (e.g., mobile application, gaming application, mobile gaming application), facilitating user interactions, introducing features, and any other suitable operation. The server system 110 includes software components and databases that can be deployed at one or more data centers in one or more geographic locations. In certain instances, the server system 110 is, includes, or utilizes a content delivery network (CDN). The server system 110, and/or any of client devices 130-136, as illustrated by FIG. 2, may include one or more software components, including a core logic component 121, a replay component 122, an autoplayer component 123, and any other suitable component for fulfilling the methods discussed herein. The software components can include subcomponents that can execute on the same or on different individual data processing apparatus. The server system 110 databases can include a task database 131 and/or an application database 133, and any suitable number of other databases that are not illustrated in FIG. 1, such as a features database, a payments database, or an authentication database. The databases can reside in one or more physical storage systems. The software components and data will be further described below.

A client application, such as a web-based application, can be provided as an end-user application to allow users to interact with the server system 110 and with other users of the server system 110 via the application. The client application or components thereof can be accessed through a network 105 (e.g., the Internet) by users of client devices, such as a personal computer 130, a smart phone 132, a laptop computer 134, or a tablet computer 136. Other client devices are possible. Additionally, or alternatively, software components for the system 100 (e.g., the core logic component 121, the replay component 122, the autoplayer component 123) or any portions thereof can reside on or be used to perform operations on one or more client devices, as shown in FIG. 2.

The system 100 includes the core logic component 121, the replay component 122, the autoplayer component 123 as being able to communicate with the task database 131 and the application database 133. The task database 131 may include one or more data structures storing one or more actions, instructions, moves, etc. for use by one or more client applications by the system 100. The application database 133 may include information about one or more client applications (e.g., games) utilizing the system 100. Such information may include client application identifiers, addresses, programming languages, linking/mapping information to underlying source code of the client application(s), and/or any other suitable information.

In one embodiment, the core logic component 121 may be responsible for maintaining match core logic. According to the embodiments of the present invention, core logic for a match can be executing on each of server system 110 and client devices 130-136. In one embodiment, core logic may be designed to run at a specific frame rate, which can be lower than the frame rate presented on the client device for graphics rendering purposes. For example, a client device could be running graphics refreshes at 60 frames per second, and the core logic of the match could be running at 5 frames per second.

In one embodiment, the core logic is deterministic, meaning that given the same starting state and same inputs, the same results occur each time the logic is executed. The core logic runs on each client device (e.g., 130-136) and on the server system 110. In this way, each participant experiences the same deterministic match progression.

In one embodiment, certain settings (e.g., rules) about how the match will behave can be embedded in the shared core logic code. Alternatively, some settings can be determined by the server, and sent initially as part of the setup data, as described below.

According to the present invention, the core logic tracks the current frame number being executed, which may be incremented through an update operation. In one embodiment, during initializing of a task of a client application, the frame number may be set to 0. Then, at the start of each update step, the frame number may be independently incremented on each of the client devices 130-136 and server system 110.

In one embodiment, in the update step, any known inputs (e.g., actions to be performed, moves to be made, etc.) that are tagged with the current frame number may be processed. If the client device has received any official inputs (e.g., input requests that have been authenticated by the server system 110), with a future frame number, those inputs may be held on to for later processing.

In one embodiment, for each frame, there may be an ordered list of user inputs, which can be, for example, the players' moves of the game. Each input may be tagged with the frame number to which it applies. Aside from that, the specifics of the input may be particular to the app, as one or more suitable inputs can be accepted and processed by the app.

In one embodiment, at the start of a match (e.g., during initialization of the task or client application), each client device 130-136 may establish a two-way connection to the server system 110, via network 105, for example. According to the present invention, the connection may guarantee in-order delivery of all data in both directions. For example, a Web Socket connection or the like may be used to satisfy such a requirement.

The details about how that server is started and how the client devices discover and connect to the server may depend on various factors, such as, for example, the configuration of the server hardware/software, the type of two-way connection used, the configuration of the client device hardware/software, and so forth. Consequently, such server and client device dependent implementation details are outside of the scope of the present description.

In one embodiment, according to the present invention, the server system 110 can transmit or otherwise send identical data streams to each client device 130-136 for the duration of the match. In one embodiment, the data is sent in real-time. As an example, the data can be in packets, where, for example, one packet can be sent for each frame of the game. Consequently, for a five-frames-per-second match, five packets may be sent each second.

The server system 110 can create initialization data, referred to herein as the “setup data,” that can define the starting state of the game. Setup data may be stored in either of task database 131 or application database 133. The server system 110 can send the setup data to each client device 130-136 as the first piece of data. The specifics of the information contained in the setup data may be particular to the application, as the setup data can contain one or more parameters, each with different possible values.

According to the present invention, the server system 110 may run an instance of the core logic code. The initial state of the core logic code instance may come from the setup data. Once the server system 110 has established connections to the client devices 130-136, the server system 110 may perform several tasks, including, for example, the following: receive “input” messages from each client device 130-136, and process them; send a message to each client device 130-136 at the start of each frame; and run the core match logic at the specified frame rate, executing the update step with each frame, until the match reaches an end state, for example.

In one embodiment, client devices 130-136 can send input messages to the server system 110. Each input message may include a frame number and additional data that may be specific to the app. In one embodiment, if the frame number of the message is not known, or is less than or equal to the server system's 110 current frame number, it can be set to the current frame number+1 or any other suitable frame number. In one embodiment, after authentication the input message is now an “official” input message. The official input message may then be queued by the server system 110 to later send to each client device.

In one embodiment, when it is time to execute the next frame, the following actions can occur: the server system 110 can send a message packet to all of the client devices 130-136. The message packet can contain, for example, the following information: the current frame number+1 (i.e., the frame number that will be set at the start of the next update); and the list of queued inputs, if any. In one embodiment, the server system 110 may then feed that same list of inputs into its instance of the core logic, execute the update step, and clear the list of inputs. If the match logic has reached an end state, the process may end.

In one embodiment, the match core logic described above is the minimal logical description of a match required to execute the rules and sequence of a match. However, the match core logic does not need to process those parts of the user experience that are visual in nature or one-way presentations. That is, the user experience may be far richer than the bare application logic processed in the core logic. Advantageously, with this level of separation, the server system 110 may be free to execute a low-cost version of the match that nevertheless achieves the full set of rules. The client devices 130-136 may then enhance this experience with logic and data for audio and visual details that may greatly enhance the user experiences. As was mentioned previously, the core logic might be executing at a slow frame rate, but the client experience can be at a high frame rate, with full 3D graphics and the like. In the core logic, a game element may be processed as a small set of numbers, but in the visual presentation, there are virtually no limits to what can be displayed (the only limit being the graphical display capabilities of the client device). The core logic described herein is purposefully designed to take advantage of this distinction.

FIG. 2 is a schematic diagram of a second example lockstep client-server system 200, in accordance with embodiments of the disclosure. System 200 may be a subset of system 100, or may be an entirely different system. In one embodiment, each client device 130-136 of system 200 runs an instance of the core logic code in addition to the instance running on server system 110 of FIG. 1. In one embodiment, the initial state of the core logic code instance may be derived from the setup data.

In one embodiment, the client device itself (any of 130-136, for example) may run at a frame rate faster than the rate used internally by the core logic. Advantageously, by interpolating between frames, the client device can smooth over the discrete steps calculated by the core logic.

In one embodiment, the client device 130-136 may rely on the messages from the server system 110 to control the timing of its core logic updates. For example, for each message received from the server system 110, the client device may execute one update of the core logic. Consequently, its frame number can always be synchronized to the latest frame number received from the server system 110.

In one embodiment, players may make inputs (e.g., request that actions be performed) at will, in a manner specific to the app. These inputs may be tentative until they are echoed back to the originating client device (e.g., 132) and others from the server system 110, at which time they may be considered authenticated and official. For each input, the client device 132 can encode the input in a message to the server system 110. The message may include an optional future frame number, indicating when the client device 132 wants this input to be handled.

In one embodiment, autoplayer component 123 of FIG. 1 and FIG. 2 may include autoplayer logic, which may replace the inputs of a human player. The following discussion provides some details regarding exemplary methods for executing autoplayer logic and communication thereof.

According to the present invention, it is possible to substitute autoplayer logic for any player in the game, or for a computer-controlled opponent. For example, the server system 110 may decide to create an autoplayer, or a player could request for an autoplayer to take over for their decision making. In the second case of a player making that choice, such a request can be sent to the server system 110 from a client device 130-136, just like any other player input, and made official by the server system 110.

Once it is determined that autoplayer logic is requested, there are several possible ways to host that autoplayer logic. According to one exemplary embodiment, the server system 110 could execute the autoplayer logic. In this case, the moves the autoplayer logic generates may be sent to all client devices 130-136 from the server system 110, and run deterministically in all instances of the core logic. According to an alternative exemplary embodiment, each client device 130-136 can run its own autoplayer logic locally. Any moves may therefore be sent up to the server system 110 in the same way as if the player had made these moves manually.

According to a further alternative exemplary embodiment, when an autoplayer is requested, it can be run locally in all instances of the core logic. The official message from the server to enable the autoplayer for a certain player may be received by each client device 130-136, and each may start the autoplayer logic deterministically. In this distributed case, the moves generated may not have to be sent to the server system 110, but just executed locally, since each instance is making the same autoplayer decisions. Certain applications may find this to be an advantage. Advantageously, in one embodiment, by starting autoplayer logic through the message protocol, and because of the execution of deterministic logic (as discussed above), autoplayer code can be processed solely on each client device 130-136, and bypass the need for sending resulting moves over the communication channels to server system 110.

In one embodiment, replay component 122 of FIG. 1 and FIG. 2 is responsible for the generation and visualization of match (e.g., application) replays. In one embodiment, matches can be stored and played back later as replays. However, according to the present invention, a replay may not be a playback of an actual (video) recording of the match to be viewed on the client device 130-136. Rather, a previous match may be reconstructed from the stored data (e.g., stored in task database 131 and/or application database 133). In particular, replay data may be built from a subset of the data sent from the server system 110 to each client device 130-136.

In one embodiment, replay data may include the setup data originally input into the deterministic logic and a list of all official inputs, including the frame number of each input, executed throughout the match (e.g., task). In some embodiments, data that may be omitted from the replay data can include a frame number of each message and entire messages that do not contain official inputs.

Advantageously, when a client device 132 plays a replay, it does not need to be in contact with the server system 110. It performs its own timing logic, calling each core logic at the appropriate frame rate. As mentioned previously, the core logic running on each client device 130-136 may be deterministic, meaning that given the same starting state and same inputs, the same results occur during each execution of the logic. Therefore, given the setup data (i.e., the starting state) and the same inputs (i.e., the list of all official inputs), the (deterministic) progression of a past game can be exactly re-constructed (e.g., on-the-fly) to allow a user to review and “relive” any moment of a previous match. Consequently, as opposed to real-time multiplayer games, replays may be paused, sped up, and slowed down.

In one embodiment, replay data may be collected by a client device 132 during the real-time play of a match. Replay data may alternatively or additionally be collected by the server system 110, stored, and later distributed to the same or other client devices 130-136 on demand. In one embodiment, a server system 110 can re-run any match from the replay data at a very fast sped up rate by executing updates at full speed, unbounded by the real-time frame rate. For purposes of illustration and not limitation, the server system 110 can use these re-runs to derive statistics, perform additional analysis, or undertake other suitable tasks on individual matches or on larger collections of stored matches. For example, the server system 110 could analyze (e.g., using suitable machine learning techniques) previous matches to identify those matches (e.g., high-scoring matches, big battles between large armies, etc.) that may be of interest to other players (e.g., based on player-specified preferences, playing habits, match viewing habits, etc.) to replay. Additionally, or alternatively, the analysis of past matches can be used by the server to identify live matches (e.g., live matches that are similar to previous high-scoring matches or previous big battles, etc.) that may be of interest to other players to spectate, as discussed in more detail below. Such recommendations can be provided to relevant client devices as part of a content generation and recommendation platform.

In one embodiment, if a client device 130-136 loses connection to the server system 110, recovery of the deterministic match logic is possible. The server system 110 is aware of the broken connection and would continue executing the match in real-time. The client device (e.g., 132) would reconnect to the server system 110. During or shortly after reconnection, the server system 110 may send a special first message to the connecting client device 132. This special first message can contain, for example, the following information: the setup data; the server system's 110 current frame number; and an exhaustive list of the official inputs that had been processed up to that frame number.

Thereafter, the server system 110 may continue to send the same real-time stream of messages to the client device 132 that it may be sending to all the other client devices 130 and 134-136. In one embodiment, the client device 132 can then execute updates for each frame from the time of disconnection to the new current frame number. The client device 132 may optionally present these frames in a sped-up manner, such as, for example, at double speed. In this way, the client device 132 can catch up to the current synchronized frame. The client device 132 can also buffer up the new live messages that it receives during this catchup time, and continue to update at the sped-up rate until it reaches the latest message. In one embodiment, player inputs may be disabled during such catch-up time.

In the above scenario, a client device 132 can rejoin after a broken connection, while still presenting the match to the player. However, it is also possible to rejoin a match after restarting the client device 132, as long as that match is still running on the server system 110 in real-time. After restarting, the client device 132 can contact the server system 110 to query whether there is a rejoin-able match in progress. If there is, the client device 132 can enter the match and connect to the server system 110. From there, the client device 132 can perform the catch up procedure as described above.

Optionally, to improve the user experience, the client device 132 could defer any visual presentation of the catch-up period. Thus, rather than running at some gated speed, the client device 132 could run updates flat out so as to catch up to the present message as quickly as possible. Visual presentation to the user could begin once the client device 132 has caught up to the present message.

Likewise, it is possible to adapt the present invention to recover from the failure of a server in real-time. In one embodiment, a monitoring system can be aware of every match started on a server system 110. For each server system 110, the monitoring system can connect as a spectator (discussed in detail below) and record the downstream data. The monitoring system can also monitor the server system 110 process to watch for any failure.

If the server system 110 fails, the monitoring system can cause a new server (e.g., of server system 110 or another server system) to start the match. The data collected by the monitoring system from the downstream recording can be sent to the new server. The new server can initialize itself with the setup data and the list of official inputs. The new server can play forward up to the last known frame number, and then wait for connections from the client devices 130-136.

In one embodiment, client devices 130-136 which lost their connections to the original server system 110 can go into a recovery state. Accordingly, the client devices 130-136 can contact the monitoring system, and, through a suitable protocol, can establish connections to the new server. When the client devices 130-136 are reconnected, the monitoring system can instruct the new server to start running at real-time speed. The client devices 130-136, still in a recovery state, can throw away all the incoming messages up to the last frame number they had previously processed. Then, the client devices 130-136 can exit the recovery state and proceed as normal.

In one embodiment, because of the few-up (to server system 110), many-down (to client devices 130-136) message pattern of the present invention, additional servers can be deployed to lessen the communication load from a single server that is hosting the server-side core game logic. Furthermore, the client devices 130-136 can take on a number of frame-rate management tasks, given that it can run at a higher frame rate than the core logic, and given the various edge cases with which it may have to deal. For instance, one example edge case can be catching up following a loss of connection, as described above.

Generally, the client device can be running at a particular frame rate, and at the same time, the core logic can be running at some different rate, possibly slower. For game state presentation details, such as the positions of walking units, to maintain smoothness the client device 132 may interpolate its presentation between the latest two states of the core logic. In the ideal case, the client device 132 can keep the interpolated logical frame at a “sweet spot,” somewhere between those latest two states. The client device 132 can make real-time measurements of when each expected packet is received, and make fine adjustments of its interpolation parameter to keep the playback smoothly sitting in this sweet spot, in a way that subjectively gives the best presentation.

In the case of bad latency, or a temporary loss of communication, the client device 132 can find that it has caught all the way up to the last frame synchronized from the server. At this point it can freeze, or it can interpolate past the most recent frame. At that time, the client device 132 can find that it has multiple frames to which to catch up. In one embodiment, to mask the initial latency in having turns acknowledged from the server, the present invention can employ several suitable presentation techniques. It can choose a method of fast-forwarding or blending that subjectively gives the best result. This choice possibly involves running at a sped-up rate until it finds itself back in the sweet spot between the most recent two frames.

In one embodiment, the operations and systems described herein include a spectator mode. The present invention supports multiple additional client devices (e.g., any of 130-136 or other client devices outside of system 100) displaying live matches in a spectator mode in real-time. That is, the client devices are not official match participants, but can still watch the live matches unfold.

When a spectator joins a live match, the procedure may be the same as that for a client device rejoining a match after restarting, as described above. Since a spectator may in some cases not provide match inputs, there is no specific need for the spectating client device to have the game presentation be synchronized to the live version of the game. Consequently, a spectator mode can let the user pause the match, play the match in slow motion, or play the match in fast forward all the way back to the live match. It is contemplated that a player can spectate any previous (non-live) match, whether from that player or any other player, using the replay functionality described above.

According to an embodiment of the present invention, for a spectator synchronized to the live match, they can in some embodiments be allowed to interact with the match, making moves that can affect the outcome of the match. The spectators can use the upstream connection to the server system 110 to send inputs into the game. These inputs may be processed by the server system 110 and applied to the live match.

In one embodiment, the system 100 can present optional interactions on which the spectators can vote. For example, the game can present a chance to apply a beneficial boost to one player or another in a particular match. Spectators can vote in real-time on which action to take. These votes can be sent to the server system 110 as inputs using the same protocols as other client device 130-136 inputs. After an appropriate time period, if the votes have exceeded a particular threshold, then the server system 110 can send the voted-for action to all participants (e.g., client devices 130-136) in the downstream messages as an official input.

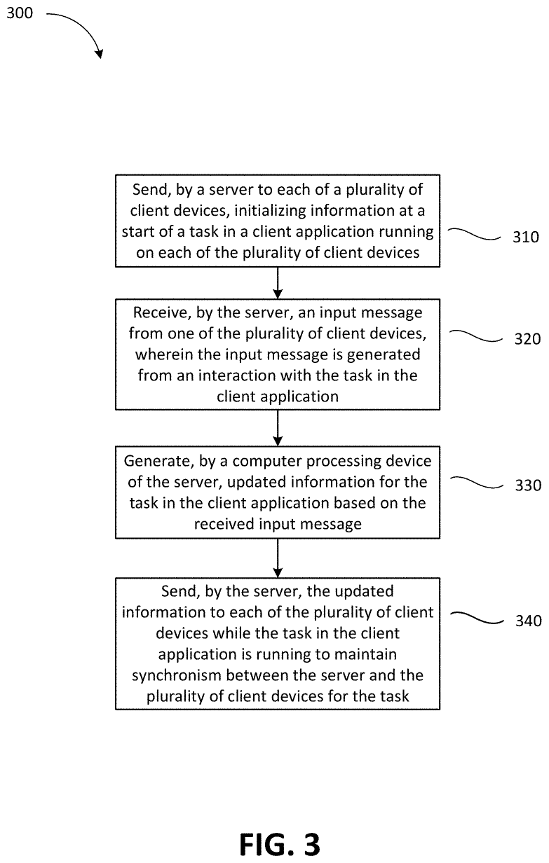

FIG. 3 is an illustration of an example of a method of lockstep client-server operations, in accordance with embodiments of the disclosure. In general, the method 300 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. For example, the processing logic may be implemented as core logic component 121, replay component 122 and/or autoplayer component 123.

Method 300 may begin at block 310, where the processing logic sends, by a server to each of a plurality of client devices, initializing information at a start of a task (e.g., a match) in a client application (e.g., core logic of a game) running on each of the plurality of client devices. In one embodiment, two-way connections between the plurality of client devices and the server guarantee in-order delivery of all data in both directions.

In one embodiment, the client application running on each of the plurality of client devices is a same version of a deterministic client application. Processing logic may, in this case, send with the initializing information, by the server during an initiation of the deterministic client application, setup data for the initiation of the deterministic client application to each of the plurality of client devices.

At block 320, processing logic receives, by the server, an input message (e.g., a request to perform a particular move or other action) from one of the plurality of client devices, wherein the input message is generated from an interaction with the task in the client application. In one embodiment, the input message includes a request of a passive spectator client device.

At block 330, processing logic generates, by a computer processing device of the server, updated information for the task in the client application based on the received input message. In one embodiment, the input message and the updated information include a frame identifier corresponding to the start of the task, and the plurality of client devices and the server each maintain a synchronized copy of a current frame number of the client application. In one embodiment, the frame number received in the input message corresponds to the current frame number. In another embodiment, the frame identifier corresponds to a future number of the client application. In this case, processing logic may delay the sending of the updated information or execution of the instruction until the current frame number matches the frame identifier.

In another embodiment, when the input message does not include a frame number corresponding to the start of the task, processing logic may assign a frame number to the start of the task and send the frame number with the updated information to the plurality of client devices.

At block 340, processing logic sends, by the server, the updated information to each of the plurality of client devices while the task in the client application is running to maintain synchronism between the server and the plurality of client devices for the task.

In one embodiment, optionally, a first frame rate corresponding to execution logic on the server is slower than a second graphics refresh frame rate corresponding to the client application on the client devices. In another embodiment, when the updated information includes an instruction to activate autonomous control for the one of the plurality of client devices, processing logic may execute identical autonomous instructions on each of the plurality of client devices without communicating the autonomous instructions between the client devices and the server. Advantageously, this is possible due to the deterministic nature of the logic executing on each of the client devices.

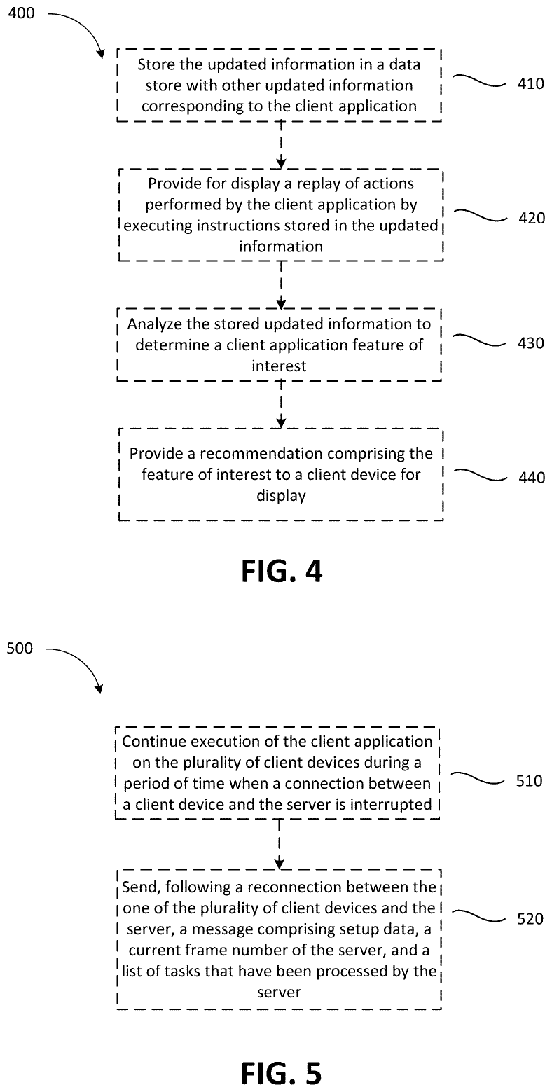

FIG. 4 is an illustration of an example of a method of lockstep client-server replay operations, in accordance with embodiments of the disclosure. In general, the method 400 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. For example, the processing logic may be implemented as core logic component 121, replay component 122 and/or autoplayer component 123.

Method 400 may begin at block 410, where the processing logic stores the updated information in a data store with other updated information corresponding to the client application. At block 420, processing logic provides for display a replay of actions performed by the client application by executing instructions stored in the updated information. Advantageously, the replay may be generated by executing the sequence of events identified in the updated information stored by processing logic, instead of capturing and displaying recorded video.

Furthermore, processing logic at block 430 may analyze (e.g., using machine learning) the stored updated information to determine a client application feature of interest or any other suitable analysis and provide a recommendation including the feature of interest to a client device for display (440).

FIG. 5 is an illustration of an example of a method of lockstep client-server recommendation operations, in accordance with embodiments of the disclosure. In general, the method 500 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. For example, the processing logic may be implemented as core logic component 121, replay component 122 and/or autoplayer component 123.

Method 500 may begin at block 510, where a connection between the one of the plurality of client devices and the server is interrupted for a period of time. Processing logic may continue execution of the client application on the plurality of client devices during the period of time (e.g., without communication with the server). Processing logic at block 520 may then send, following a reconnection between the one of the plurality of client devices and the server, a message comprising setup data, a current frame number of the server, and a list of tasks that have been processed by the server. Advantageously, using the provided information, the client device may catch up and re-enter gameplay with minimal delay.

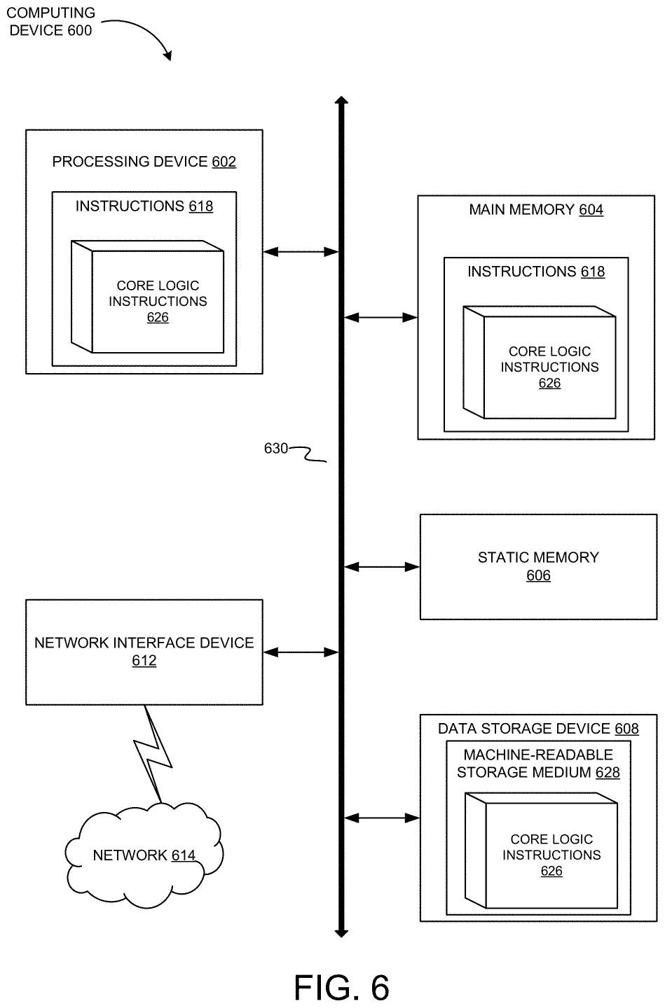

FIG. 6 is a block diagram of an example computing device 600 that may perform one or more of the operations described herein, in accordance with the present embodiments. The computing device 600 may be connected to other computing devices in a LAN, an intranet, an extranet, and/or the Internet. The computing device 600 may operate in the capacity of a server machine in client-server network environment or in the capacity of a client in a peer-to-peer network environment. The computing device 600 may be provided by a personal computer (PC), a set-top box (STB), a server, a network router, switch or bridge, or any machine capable of executing a set of instructions (sequential or otherwise) that specify actions to be taken by that machine. Further, while only a single computing device 600 is illustrated, the term “computing device” shall also be taken to include any collection of computing devices that individually or jointly execute a set (or multiple sets) of instructions to perform the methods discussed herein.

The example computing device 600 may include a computer processing device (e.g., a general purpose processor, ASIC, etc.) 602, a main memory 604, a static memory 606 (e.g., flash memory and a data storage device 608), which may communicate with each other via a bus 630. The computer processing device 602 may be provided by one or more general-purpose processing devices such as a microprocessor, central processing unit, or the like. In an illustrative example, computer processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 602 may also comprise one or more special-purpose processing devices such as an application specific integrated circuit (ASIC), a field programmable gate array (FPGA), a digital signal processor (DSP), network processor, or the like. The computer processing device 602 may be configured to execute the operations described herein, in accordance with one or more aspects of the present disclosure, for performing the operations and steps discussed herein.

The computing device 600 may further include a network interface device 612, which may communicate with a network 614. The data storage device 608 may include a machine-readable storage medium 628 on which may be stored one or more sets of instructions, e.g., instructions for carrying out the operations described herein, in accordance with one or more aspects of the present disclosure. Instructions 618 implementing core logic instructions 626 may also reside, completely or at least partially, within main memory 604 and/or within computer processing device 602 during execution thereof by the computing device 600, main memory 604 and computer processing device 602 also constituting computer-readable media. The instructions may further be transmitted or received over the network 614 via the network interface device 612.

While machine-readable storage medium 628 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, or solid state drives. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method, comprising:
sending, by a server to each of a plurality of client devices, initializing information at a start of a task in a client application running on each of the plurality of client devices;
receiving, by the server, an input message from one of the plurality of client devices, wherein the input message is generated from an interaction with the task in the client application;
generating, by a computer processing device of the server, updated information for the task in the client application based on the received input message; and
sending, by the server, the updated information to each of the plurality of client devices while the task in the client application is running to maintain synchronism between the server and the plurality of client devices for the task.

2. The method of claim 1, wherein the client application running on each of the plurality of client devices is a same version of a deterministic client application, further comprising sending with the initializing information, by the server during an initiation of the deterministic client application, setup data for the initiation of the deterministic client application to each of the plurality of client devices.

3. The method of claim 1, wherein the input message and the updated information comprise a frame identifier corresponding to the start of the task, and wherein the plurality of client devices and the server each maintain a synchronized copy of a current frame number of the client application.

4. The method of claim 3, wherein the frame identifier corresponds to a future number of the client application, further comprising delaying the sending of the updated information until the current frame number matches the frame identifier.

5. The method of claim 1, wherein the input message does not comprise a frame number corresponding to the start of the task, the method further comprising:
assigning a frame number to the start of the task; and
sending the frame number with the updated information to the plurality of client devices.

6. The method of claim 1, wherein two-way connections between the plurality of client devices and the server guarantee in-order delivery of all data in both directions.

7. The method of claim 1, wherein a first frame rate corresponding to execution logic on the server is slower than a second graphics refresh frame rate corresponding to the client application on the client devices.

8. The method of claim 1, wherein the updated information comprises an instruction to activate autonomous control for the one of the plurality of client devices, the method further comprising executing identical autonomous instructions on each of the plurality of client devices without communicating the autonomous instructions between the client devices and the server.

9. The method of claim 1, further comprising:
storing the updated information in a data store with other updated information corresponding to the client application; and
providing for display a replay of actions performed by the client application by executing instructions stored in the updated information.

10. The method of claim 9, further comprising:
analyzing the stored updated information to determine a client application feature of interest; and
providing a recommendation comprising the feature of interest to a client device for display.

11. The method of claim 1, wherein a connection between the one of the plurality of client devices and the server is interrupted for a period of time, the method further comprising:
continuing execution of the client application on the plurality of client devices during the period of time; and
sending, following a reconnection between the one of the plurality of client devices and the server, a message comprising setup data, a current frame number of the server, and a list of tasks that have been processed by the server.

12. The method of claim 1, wherein the input message comprises a request of a passive spectator client device.

13. A server system, comprising:
a memory to store initializing information; and
a computer processing device, operatively coupled to the memory, to:
send, to each of a plurality of client devices, the initializing information at a start of a task in a client application running on each of the plurality of client devices;
receive an input message from one of the plurality of client devices, wherein the input message is generated from an interaction with the task in the client application;
generate updated information for the task in the client application based on the received input message; and
send the updated information to each of the plurality of client devices while the task in the client application is running to maintain synchronism between the server and the plurality of client devices for the task.

14. The server system of claim 13, wherein the client application running on each of the plurality of client devices is a same version of a deterministic client application, further comprising sending with the initializing information, by the server during an initiation of the deterministic client application, setup data for the initiation of the deterministic client application to each of the plurality of client devices.

15. The server system of claim 13, wherein the initializing information and the updated information comprise a frame identifier corresponding to the start of the task, and wherein the plurality of client devices and the server each maintain a synchronized copy of a current frame number of the client application.

16. The server system of claim 13, wherein the updated information comprises an instruction to activate autonomous control for the one of the plurality of client devices, the computer processing device further to execute identical autonomous instructions on each of the plurality of client devices without communicating the autonomous instructions between the client devices and the server.

17. A non-transitory computer-readable medium having instructions stored thereon that, when executed by a computer processing device of a server, cause the computer processing device to:
send, by the server to each of a plurality of client devices, initializing information at a start of a task in a client application running on each of the plurality of client devices;
receive, by the server, an input message from one of the plurality of client devices, wherein the input message is generated from an interaction with the task in the client application;
generate, by the computer processing device of the server, updated information for the task in the client application based on the received input message; and
send, by the server, the updated information to each of the plurality of client devices while the task in the client application is running to maintain synchronism between the server and the plurality of client devices for the task.

18. The non-transitory computer-readable medium of claim 17, the computer processing device further to:
store the updated information in a data store with other updated information corresponding to the client application; and
provide for display a replay of actions performed by the client application by executing instructions stored in the updated information.

19. The non-transitory computer-readable medium of claim 18, the computer processing device further to:
analyze the stored updated information to determine a client application feature of interest; and
provide a recommendation comprising the feature of interest to a client device for display.

20. The non-transitory computer-readable medium of claim 17, wherein a connection between the one of the plurality of client devices and the server is interrupted for a period of time, the computer processing device further to:
continue execution of the client application on the plurality of client devices during the period of time; and
send, following a reconnection between the one of the plurality of client devices and the server, a message comprising setup data, a current frame number of the server, and a list of tasks that have been processed by the server.
